(19) United States
(12) Patent Application Publication
(10) Pub. No.: US 2018/0174234 A1
(43) Pub. Date: Jun. 21, 2018

(54) METHOD OF SELLING A MORTGAGE

(71) Applicant: BIDELOAN PTY LTD, North Adelaide (AU)

(72) Inventor: Scott Matthews, North Adelaide (AU)

(73) Assignee: BIDELOAN PTY LTD

(21) Appl. No.: 15/381,947

(22) Filed: Dec. 16, 2016

(51) Int. Cl. G06Q 40/04; G06Q 50/16

(52) U.S. Cl. CPC G06Q 40/04; G06Q 50/163

(57) ABSTRACT

A system that provides for the sale of a product or products by allowing purchasers to bid on the right to purchase the product. The system makes a set number of purchase rights available for sale and limits the number of rights available for sale or the time available for sale or both thus creating a market for purchase rights. Registered, qualified purchasers bid for the value of the right to purchase the product. Purchasers may also elect to purchase a right at a maximum purchase value thus securing the immediate purchase of the right. Purchasers pay a deposit to secure their purchase right and pay the balance after passing a qualification process to verify eligibility to purchase the product.

An exemplary implementation is the use of the system to allow purchasers to bid for the right to purchase mortgages. The right to purchase the mortgage is the mortgage application fee. Winning purchasers pay a deposit on the application fee and pay the balance once they have qualified for the mortgage.

### FIELD OF THE INVENTION

The present invention relates to a system for the online sales of the right to purchase a good or service or a set of goods or services. An exemplary manifestation is the online sales of the right to purchase mortgages, in particular mortgages at wholesale interest rates sold without commission and on the basis of payment of a single up-front application fee.

The example of using the invention for the purchases of mortgage by way of an up-front fee does not limit the use of this invention to other implementations.

### BACKGROUND TO THE INVENTION

Some markets are suitable for the sale of the right to purchase a product by way of purchase of a right to purchase the product. An example would be the purchase or the right to purchase a product by payment of an up-front fee the product which would otherwise be purchased by payment of a commission. A further example would be the purchase of a product by payment of an up-front fee the product which would otherwise be purchased by payment of an up-front commission and then payment of an ongoing commission, or ‘trail’, over an extended period of time. A further example would be the purchase of a mortgage by way of payment of an up-front fee the mortgage which would otherwise be purchased by payment of an up-front commission and an ongoing ‘trail’ for the life of the mortgage.

The Australian mortgage currently has a worth of approximately $400,000,000. Predominantly all mortgages sold in the market contain a commission structure which consists of an up-front commission which is a percentage of the value of the mortgage as well as a ‘trail’ being a smaller commission which is paid during the life of the mortgage.

The overwhelming bulk of mortgages are sold in the traditional manner, this being face-to-face interaction between purchaser and lender. The lender may be a bank or mortgage originator.

The commission structure presents little incentive for online mortgage sales as little additional value is provided by purchasing a mortgage online. As a result the online mortgage market occupies approximately 4%, or $15,000,000 of the overall mortgage market.

Charging commissions, particularly over the life of the mortgage, increases the cost of the mortgage to the purchaser as well as provides a disincentive to innovation, particularly in the online space, for the sale of mortgages to purchasers.

### SUMMARY OF THE INVENTION

In a first aspect the invention comprises a system to enable the sale of goods or services by bidding for the right to purchase the good or service.

In an exemplary implementation the invention comprises a system to enable the sale of mortgages by replacing the commission structure by payment of an up-front fee and enabling prospective purchasers to bid for the right to purchase a mortgage by bidding for the value of the up-front fee.

The system presents a fixed number of goods or services as available for purchase as a Rights Unit (RU) over a fixed period of time. That is a fixed number of rights to purchase (R2P).

Retail Purchasers (RP) register on the system and are subjected to a qualification process. A qualified RP is permitted to bid for R2P.

They system consists of a competitive bidding engine (‘CBE’) which accepts bids on R2P.

The CBE provides a means for the RP to pay a fixed ‘immediate purchase’ amount thus enabling the RP to bypass the bidding process and pay the maximum price for the R2P.

The CBE conducts a bidding process for an application fee over a fixed period of time known to all retail purchasers bidding on the R2P.

Retail purchasers compete for the price of an R2P using the CBE of the system.

The system awards R2P to the highest bidders for the period the RU was subject to the bidding process. For example, if the RU consists of 100 R2P then the top 100 bidders are awarded one R2P each. In another example if the RU consists of 100 R2P and 15 were purchased using the ‘immediate purchase’ component of the system, then the top 85 bidders are awarded the remaining R2P.

The system consists of a Payment Engine (‘PE’) with which the retail purchaser must interact and supply an initial payment or deposit.

After verification of the RP's suitability and settlement of the purchase of the good or service, the RP must pay the balance of the application fee to the Payment Engine (PE) of the system.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a flow chart showing the operation of the Rights Sale Engine (RSE) component of the invention.

FIG. 2 is a flow chart showing the operation of the Competitive Bidding Engine (CBE) component of the invention.

FIG. 3 is a flow chart showing the operation of the Customer Registration Engine (‘CRE’) component of the invention.

FIG. 4 is a flow chart showing the operation of the Payment Engine (PE) component of the invention.

FIG. 5 is a flow chart showing the operation of the Presentation Engine (PRE) component of the invention.

### DRAWING COMPONENTS

The drawings include the following integers.
100 A RU which includes: number of R2P to sell, minimum bid price, ‘immediate purchase’ price, bid start and end times.
210-250 Competitive Bidding Engine
140 Allocation of R2P to winning RPs.
150-190 Processing of successful bids.
310 Collect RP data for registration.
320 Collect qualification data to qualify RP as valid bidder in the system.
330 RP qualification verification system.
410-430 Payment Engine
610-660 Presentation Engine

### DETAILED DESCRIPTION OF THE INVENTION

The following detailed description of the invention refers to the accompanying drawings. Wherever possible, the same reference numbers will be used throughout the drawings and the following description to refer to the same and like components.

The present invention provides a system which sells the rights to purchase a good or services (products).

Products are sold by a competitive bidding process on the right to purchase the product (R2P).

The system provides the means to sell a large volume of R2P products to RP for the payment of an up-front fee and no other fees or charges.

A fixed set of products is represented to the system as a Rights Unit (RU). The RU consists of the number and type of product, minimum and maximum bid prices and bidding start and end times (100).

A large number of RU can be stored in the system (105) to enable multiple bids on multiple products to take place.

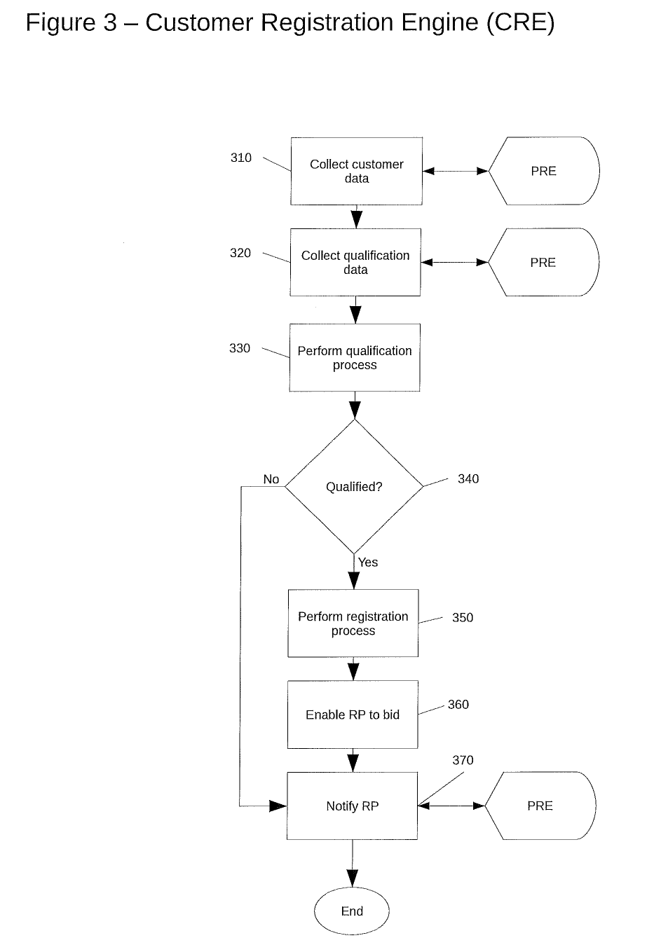

RP wishing to purchase products register their interest with the system through the CRE (FIG. 3). Customer data, for example email addresses and phone numbers, is collected (310). Qualification data is collected (320) so that a prospective RP can be validated according to criteria set in the system. A verification process is performed (330) and the customer is registered (340-360) and notified regardless of the outcome (370).

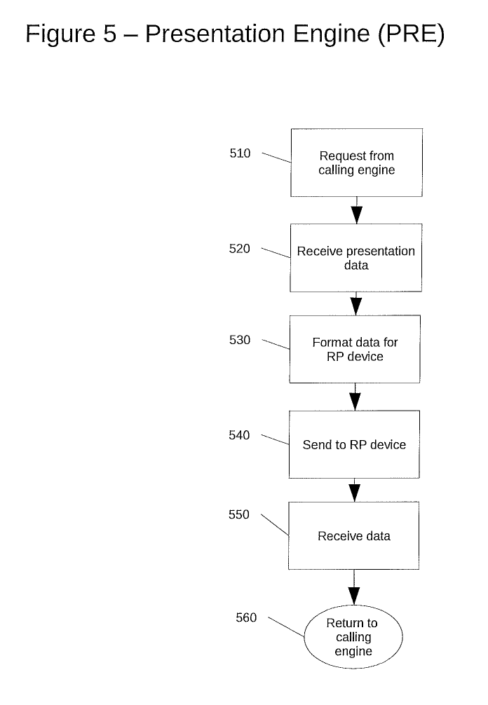

The CRE (FIG. 3) requests data from a prospective RP by sending data to a device owned by the owner. The information is presented in an easily processable means using the PRE (FIG. 5). The PRE presents information to the RP (520-530), receives and processes the input data (540) and returns the data to the calling Engine, in this case the CRE.

The PRE is designed to communicate with any of the Engines in the system (510).

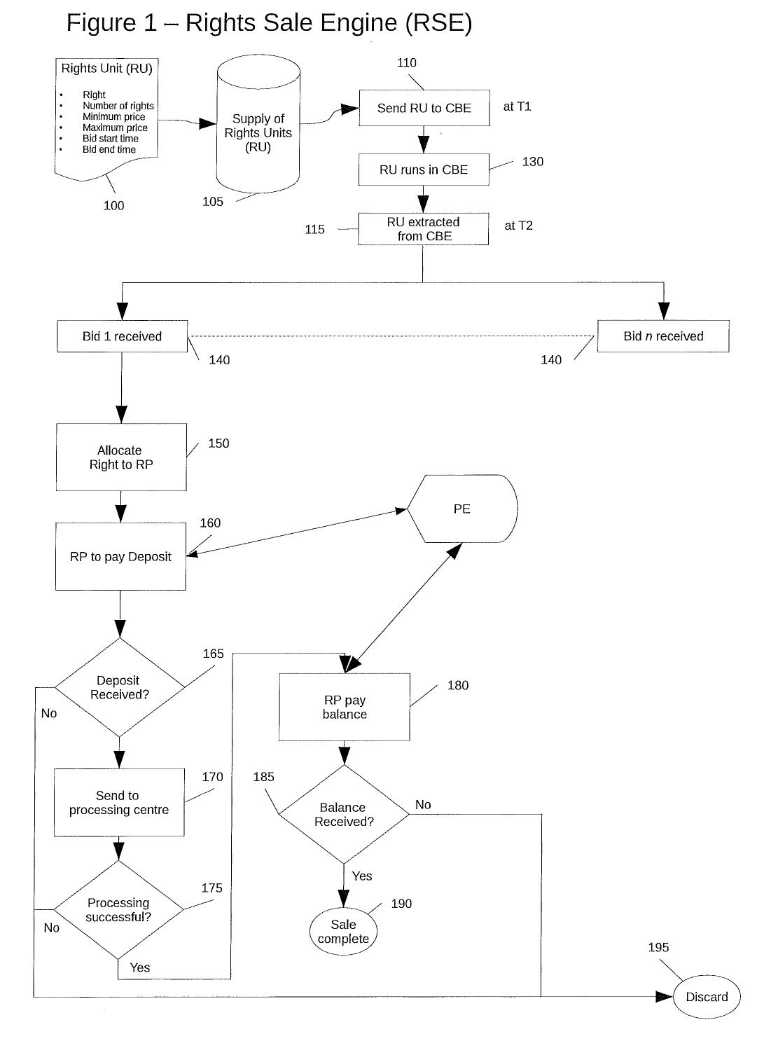

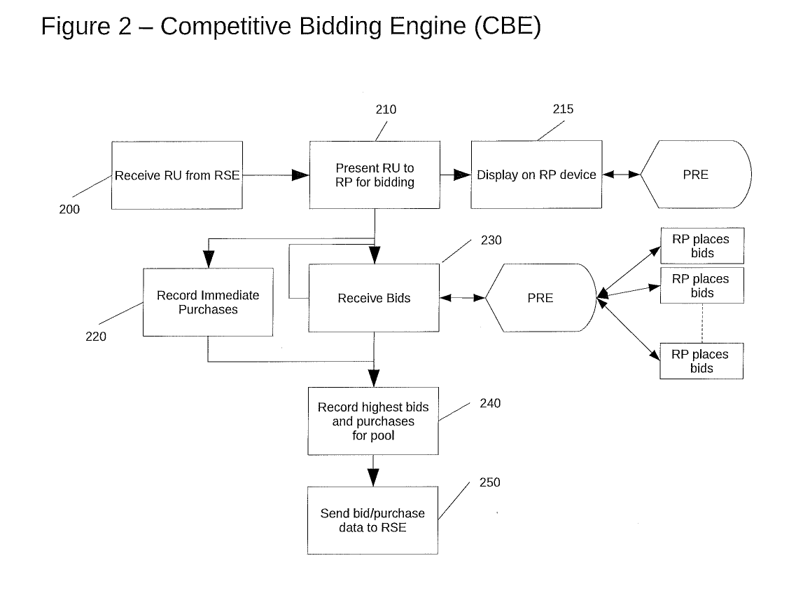

At a specified time (T1) the RSE (FIG. 1) extracts a RU for sale (110) and presents the RU to the CBE (FIG. 2). After a specified time (T2) the RSE notifies the CBE to terminate the bidding process (115) and processes bids received.

The CBE manages the bidding process. The CBE advertises the available RU to RP (210, 215) by way of the PRE. The CBE accepts bids on R2P from RP while it is active (230). If a purchaser wishes to execute an ‘immediate purchase’ the CBE manages this also (220). At the end of the bidding period the CBE returns information about the winning bids and ‘immediate purchases’ to the RSE (240, 250, 115, 140) for processing. The RSE allocates the rights to each winning RP (150) and then requests the RP pay a deposit to secure the bid (160). If the deposit is not received the right is removed from the RP (195). If the deposit is received the R2P is sent for processing and validation (170, 175). On completion of successful processing and settlement the RSE requires the RP pay the balance of the bid (180). The trade completes successfully once the balance has been successfully paid (185, 190).

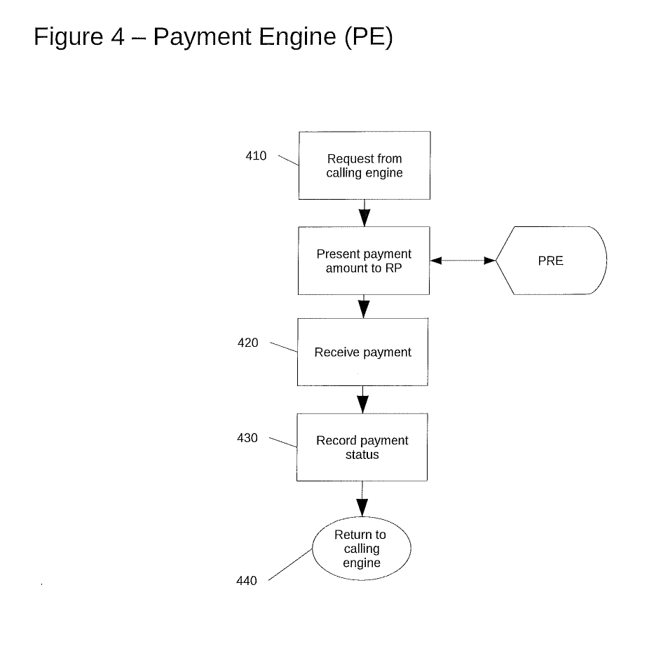

The PE (FIG. 4) is used to receive and process payments. The PE receives a payment request from an originating Engine (410), process the payment (420, 430) and send status back to the originating Engine (440).

The reader will now appreciate the present invention which provides a system for the sale of wholesale mortgages to retail purchasers by way of payment of an up-front application fee and no ongoing commissions or charges.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A method that provides for the sale of a product by making available for sale the right to purchase the product.

2. The method in claim 1 where a set number of rights to purchase a product are made available for sale to purchasers.

3. The method in claim 1 where purchasers are registered and validated prior to being granted the ability to purchase rights for sale.

4. The method in claim 1 where a purchaser may secure a purchase right by payment of a deposit and then pay the balance after the purchaser has qualified to purchase the product to which the purchase right attaches.

5. The method in claim 2 where purchasers competitively bid on the price of the purchase rights for sale.

6. The method in claim 5 where purchasers bid over a fixed period of time.

7. The method in claim 5 where a purchaser may pay an ‘immediate purchase’ price to immediately secure the purchase right.

8. An exemplary implementation of claim 1 where the product sold is a mortgage and purchasers bid on the right to purchase a mortgage, paying a deposit to secure the right while the ability of the purchaser to qualify for the mortgage is confirmed and then paying the balance of the purchase right after confirmation and so purchasing the mortgage.

9. A further example is the implementation of these claims by using a computer system connected to the internet and making purchase rights available on the computer system and enabling purchasers to connect to the system by means of an internet browser or internet-connected device to participate in the purchase process.
